(19) United States
(12) Patent Application Publication
(10) Pub. No.: US 2012/0068567 A1
(43) Pub. Date: Mar. 22, 2012

(54) POLYPHASIC AXIAL ELECTRIC CURRENT GENERATOR WITH PIVOTING MAGNETS

(75) Inventor: Carlos A. Plata, Panama (PA)

(73) Assignees: ANDEAN UNIVERSITY FUNDATION SECTIONAL PEREIRA, Pereira (CO); MEGAION RESEARCH CORPORATION, Panama (PA)

(21) Appl. No.: 13/239,057

(22) Filed: Sep. 21, 2011

Related U.S. Application Data
(60) Provisional application No. 61/384,988, filed on Sep. 21, 2010.

(51) Int. Cl. H02K 1/28

(52) U.S. Cl. 310/156.08

(57) ABSTRACT

A motor or generator has a design that allows resistive magnetic forces that restrict the movement of the rotor to be diminished, thus increasing efficiency. A pivoting rotor design allows magnets on the rotor to break the magnetic field first in the center of the rotor due to the attraction of other magnets. The generator or motor includes a drive shaft, and at least one generator or motor stage including two stators interleaved with one rotor having a plurality of pivoting frames each including at least one magnet.

### CROSS-REFERENCE TO RELATED APPLICATIONS

This Non-provisional application claims the benefit of priority to U.S. Provisional Application Nos. 61/384,988 filed Sep. 21, 2010, the entire contents of which are hereby incorporated by reference.

### BACKGROUND OF THE INVENTION

1. Field of the Invention

The present invention relates, in general, to motors and generators, and, more particularly, to increasing efficiency thereof using a pivoting magnet rotor design.

2. Relevant Background

Motor and generator design is well known. A typical AC motor includes an outside stationary stator having coils supplied with AC current to produce a rotating magnetic field, and an inside rotor attached to the output shaft that is given a torque by the rotating field.

Conventional electric motors employ magnetic forces to produce either rotational or linear motion. Electric motors operate on the principle that when a conductor, which carries a current, is located in the magnetic field, a magnetic force is exerted upon the conductor resulting in movement. Conventional generators operate through the movement of magnetic fields thereby producing a current in a conductor situated within the magnetic fields.

In a conventional design for an electric motor, adding an electrical current to the coils of an induction system creates a force through the interaction of the magnetic fields and the conducting wire. The force rotates a shaft. Conventional electric generator design is the opposite. By rotating the shaft, an electric current is created in the conductor coils. However, the electric current will continue to oppose the force rotating the shaft. This resistance will continue to grow as the speed of the shaft is increased, thus reducing the efficiency of the generator. In a generator where a wire is coiled around a soft iron core (ferromagnetic), a magnet may be drawn by the coil and a current will be produced in the coil wire. However, the system would not create an efficient generator due to the physical reality that it takes more energy to pull the magnet away from the soft iron core of the coil than would be created in the form of electricity by the passing of the magnet.

As a result, there is a need for a motor or generator wherein the magnetic drag may be substantially reduced such that there is little resistance while the magnets are being drawn away from the coils. Furthermore, there is a need for a motor or generator that minimizes the impact of the magnetic drag.

### SUMMARY OF THE INVENTION

Briefly stated, the present invention involves a design that allows resistive magnetic forces that restrict the movement of the rotor to be diminished, thus increasing the efficiency of the generator or motor. To overcome the magnetic field, a pivoting rotor design of the present invention allows the magnet on a pivoting frame of the rotor to break the magnetic field first in the center of the rotor due to the attraction of other magnets. In a first embodiment, the generator or motor of the present invention includes a drive shaft, and at least one generator or motor stage including two stators interleaved with one rotor having a plurality of pivoting frames each including at least one magnet. In a second embodiment, a linear version can be used having a skate and rail configuration.

### BRIEF DESCRIPTION OF THE DRAWINGS

FIG. 1 shows an expanded view of a first stator, a rotor having pivoting frames, and a second stator, according to the present invention;

FIG. 2 shows an alternative rotor according to the present invention;

FIG. 3 shows a rotor according to the present invention with a first embodiment of a startup spring configuration;

FIG. 4 shows a rotor according to the present invention with a second embodiment of a startup spring configuration;

FIG. 5 shows a motor or generator according to the present invention having three rotors and four stators;

FIG. 6 shows a linear skate/rail embodiment according to the present invention with the skate at an initial position;

FIG. 7 shows the linear skate/rail embodiment according to the present invention with the skate at a first intermediate position;

FIG. 8 shows the linear skate/rail embodiment according to the present invention with the skate at a second intermediate position; and

FIG. 9 shows the linear skate/rail embodiment according to the present invention with the skate at a final position.

### DETAILED DESCRIPTION OF THE PREFERRED EMBODIMENTS

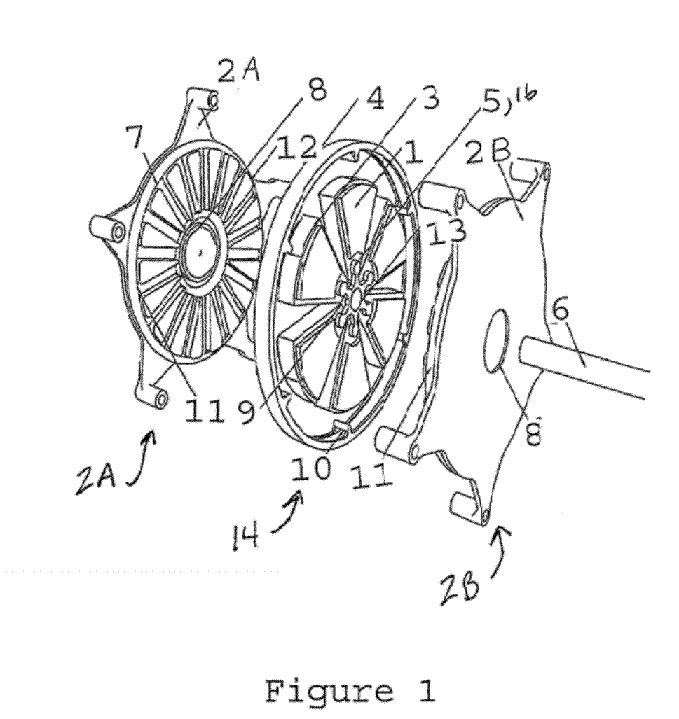

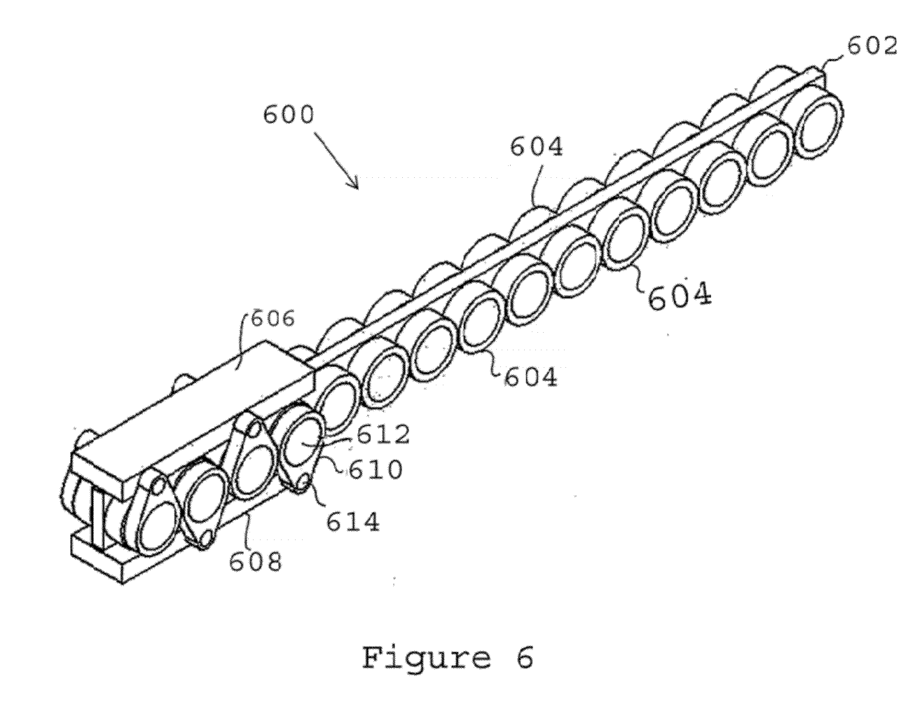

The present invention is illustrated and described in terms of a motor or generator with respect to accompanying drawing FIGS. 1-5. Since the present invention can be applied to either a motor or a generator, these terms can be used interchangeably and recitation of one term without the other is sometimes used in the description of the invention. The present invention is also illustrated and described in terms of a linear embodiment that can be a motor or generator with respect to accompanying drawing FIGS. 6-9.

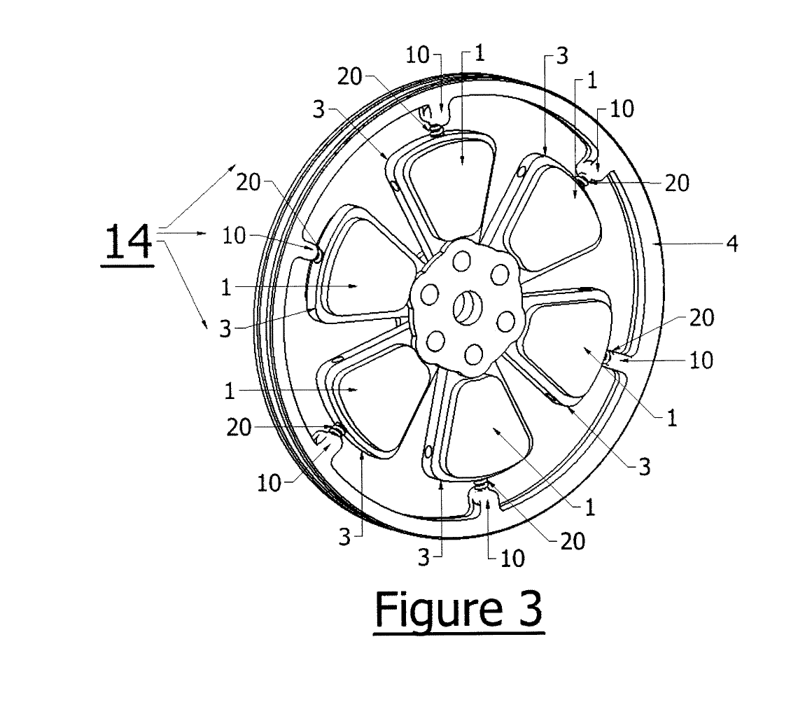

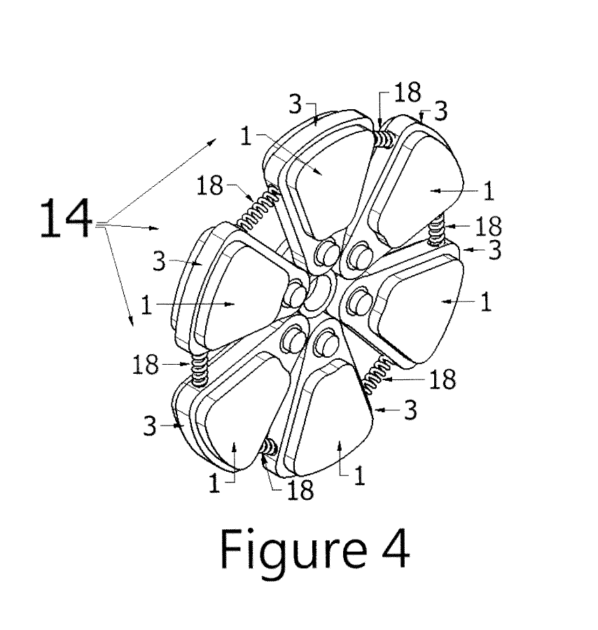

Referring now to FIG. 1, a first embodiment of the invention comprises a drive shaft and at least one generator stage that includes two stators interleaved with one rotor, but the efficiency of the device increases as more rotors and stators are coupled. The mechanism that relates the rotor and the stators has the following parts: a rotor 14 with a hub 16 including one or more plates (top view plate visible in FIG. 1, bottom view plate not visible in FIG. 1) that are crossed through its center shaft hole 13 by a rotation shaft 6. Each rotor 14 has a plurality of metallic (or other suitable material) frames 3, each having at least one magnet 1. A magnet 1 can be placed on the front and back side of the frame 3, although only a front side magnet is shown in FIG. 1. The magnets are assembled on a metallic frame 3 with a trapezoidal shape, although other shaped magnets and frames are of course possible. In the embodiment shown in FIG. 1, each frame 3 has a hole on its narrower section that assembles it to the hub of the rotor using a pin 5, which allows the metallic frame 3 to pivot or swing. (The pin 5 for attaching the frames 3 to the hub 16 can be seen in greater detail in FIGS. 3 and 4.) Other means or methods of attaching the frames 3 to the hub 16 can be used. Note that in FIG. 1, each magnet 1 is fixed to the metallic frame 3, but the frame and magnet assembly is free to rotate with respect to the hub 16. Different geometries can be used for the hub 16, frames 3, and magnets 1.

Rotor 14 also includes an optional damper 4 or balance wheel that is coupled to the magnetic frames and is described in further detail below with respect to FIG. 3.

In FIG. 1, two stator plates 2A and 2B are shown that include radial protrusions 12 where conductive coils 11 are mounted. Each stator plate 2A and 2B includes a central bearing bushing 8 for receiving the shaft 6. With respect to the rotor 14 of FIG. 1 each magnet 1 is aligned so that it faces the protrusion 12 where the conductive coil 11 is mounted.

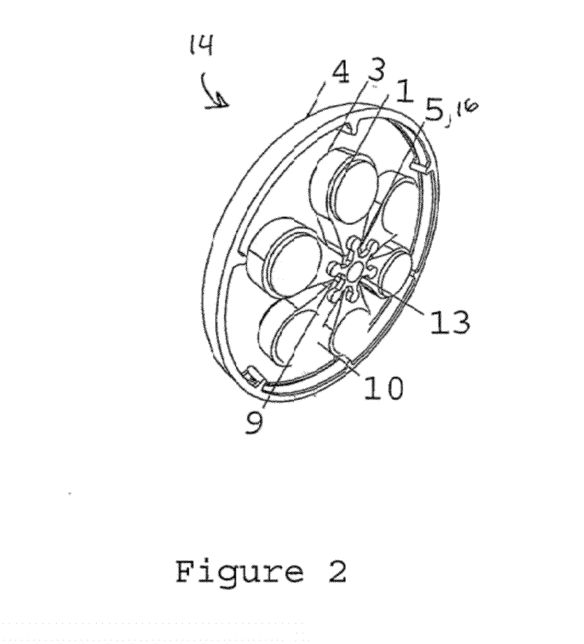

Referring now to FIG. 2, a second embodiment of the rotor 14 is shown, in which the magnets 1 are circular and not trapezoidal as shown in FIG. 1. Correspondingly, the shape of metallic frames 3 has been changed to accommodate the circular shape of the magnets 1. The metallic frames 3 are attached to the hub 16 through pins 5, or with any means that allows the frames 3 to rotate or flex with respect to the hub 16. Hub 16 includes a shaft hole 14 as was shown in FIG. 1. Rotor 14 in FIG. 2 also includes a damper or balance wheel 4, having a plurality of pins that is explained in further detail below with respect to FIG. 3.

Referring now to FIG. 3, the rotor 14 of the present invention can include a damper or balance wheel 4 having a series of springs 20 for attaching pins 10 to each frame 3. The purpose of damper 4 is to pull the magnets 1 away from the corresponding stator coil, forcing the magnets to take a perpendicular position with respect to the rotation shaft of the generator. The purpose of positioning the magnet 1 in this way is to diminish the resistive magnetic forces, which restrict the movement of the rotor 14, caused by the electromagnetic field created when electricity is generated. The purpose is similar in the motor application.

With respect to FIG. 4, rotor 14 can include optional spring separators 18 that are used during a startup phase and to avoid collisions between magnets 1 on metallic frames 3.

In operation, once the rotation force that moves the generator is exerted on the hub 16, a balancing movement around the axis upon which magnet 1 is held takes place. Such pivoting movement more easily overcomes the magnetic attraction between the coils in the stator and the magnets of the rotor. Springs 20, held between the metallic frames 3 and the damper 4, straighten the magnets 1 towards the radial protrusions 12 pulling the magnet towards the next position facing the stator.

The motor or generator described above provides an improvement in efficiency due to the swinging or pivoting magnets that reduce the force required for movement. It should be realized, however, that none of the described parts are off-the-shelf items, although the materials used are commercially available.

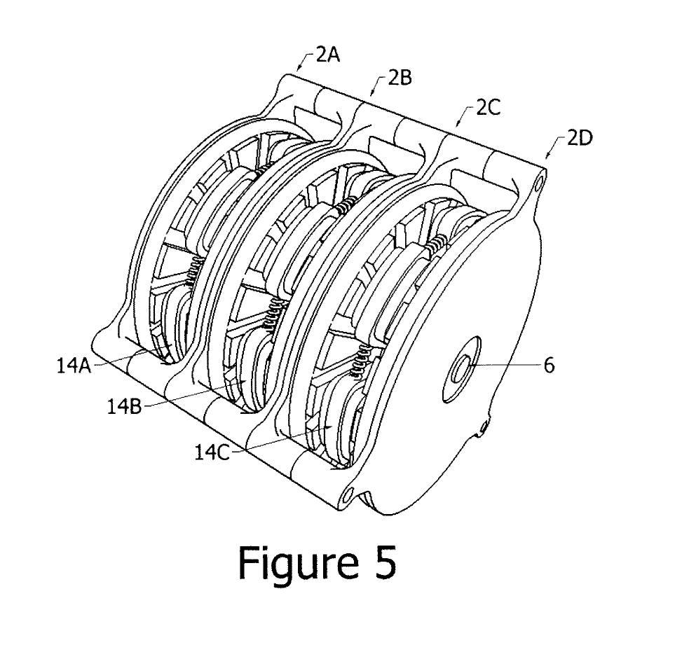

The device described comprises a drive shaft and at least one generator stage, which include two stators interleaved with one rotor. The number of magnets, rotors and stators can be modified to achieve greater generating capacity. For example, in FIG. 5 four stators 2A, 2B, 2C, and 2D are used with interleaved rotors 14A, 14B, 14C, and 14D connected to a central shaft 6. Similarly, the size of the components can be modified to make very small or very large generators or motors. As previously described, the device can be used as a generator or a motor.

According to the method of the present invention, efficiency is realized by pivoting magnets that ease breaking the magnetic field. The pivoting movements of the magnets help the magnets perform their function in the electric current generator or motor mechanism in a better manner. These pivoting movements using elements like the pins, bearings and the shaft, allows separating the magnet from the position where the rotor is attracted to the stator, which is precisely the resistive force that opposes to the movement of the rotor in the direction of rotation that generates energy or yields work.

In a linear version of the device 600 of the present invention shown in FIG. 6, a skate having a top portion 606 and a bottom portion 608 replaces the rotor component of the generator described above. A plurality of frames 610 are attached to the skate in a manner that allows the frames to flex or pivot with respect to the skate. At least one magnet 612 is attached to each frame. The stator component, which contains the coils 604, is a rail 602 through which the skate slides. As the skate 606, 608 slides across the rail 602, the magnetic fields of its magnets 612 induce an electric current in the coils 604 generating electricity.

In the linear configuration shown in FIGS. 6-9, like the axial version of the device of the present invention, the flexing or oscillating movement of the frames 610 attached to the skate 606, 608 reduces the resistance to movement by easing breaking of the magnetic attraction force between the magnets 612 and the coils 604 of the stator 602.

When electricity is generated, the coil 604 of the stator 602 creates an electromagnetic field that has the inverse polarity of the magnetic field that is moving immediately in front of it. Such inverse polarity creates an attraction force between the coil 604 and the magnet 612 of the skate 606, 608 that restricts the sliding movement of the skate.

The next magnet 612 on the skate has a polarity different to that of the previous, in a manner that when it faces a coil 604, such coil will generate electricity and create an electromagnetic field with an inverse polarity to that of the previous coil. This electromagnetic field initially repels the previous position magnet 612 of the skate 606, 608. Then, the sliding movement of the skate 606, 608 together with the flexing movement of the frame 610 forces the previous position magnet of the skate to face the coil 604 changing this coil's polarity. Such change in the coil's polarity attracts the previous position magnet 612, and the process described in the above paragraph repeats itself.

The device 600 has springs that return the magnets 612 to a perpendicular position, forming a 90° angle between the pivoting axis and the sliding axis of the skate's rail 602. Springs seek such position because the greatest electricity generation capacity occurs when the greatest portion a magnet is placed in front of the coil.

FIGS. 6-9 illustrate coils 604 having a circular shape. However, these coils 604 can have other geometries. While other geometries can be used, it is important to note that these coils are built such that they have consecutively different polarities. This is achieved by alternating the direction in which the copper wiring is coiled. For instance, the first coil wiring can be wired clockwise, the next counter clockwise, and so on. Likewise, the frames 610 and magnets 612 can have other geometries. While frame 610 is shown to be attached to the respective skate portion 606 or 608 with a pin 614, other types of attachment having the ability to flex or rotate are also possible, consistent with the principles of the present invention.

The linear device 600 shown in FIGS. 6-9 can operate as a generator or a motor. When working as generator, a mechanical force is applied to the skate 606, 608 making it slide over the rail 602. Such sliding movement generates electricity through the coils 604 of the stator component 602. Alternatively, when working a motor, electrons travel through the coils 604 creating electromagnetic fields that move the magnets 612 on the skate 606, 608. Such movements of the magnets 612 push the skate 606, 608 creating a mechanical force.

FIG. 6 shows a linear skate/rail embodiment 600 according to the present invention with the skate at an initial position.

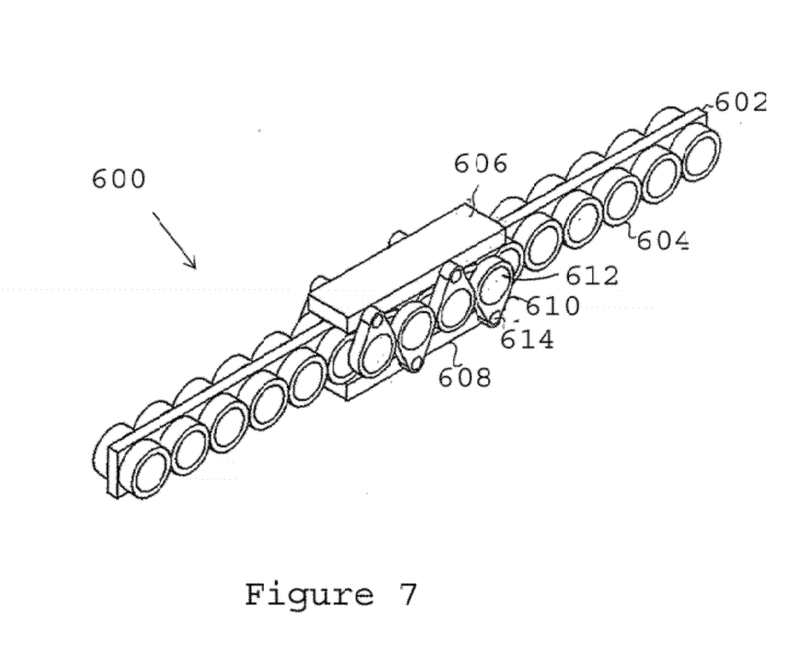

FIG. 7 shows the linear skate/rail embodiment 600 according to the present invention with the skate at a first intermediate position.

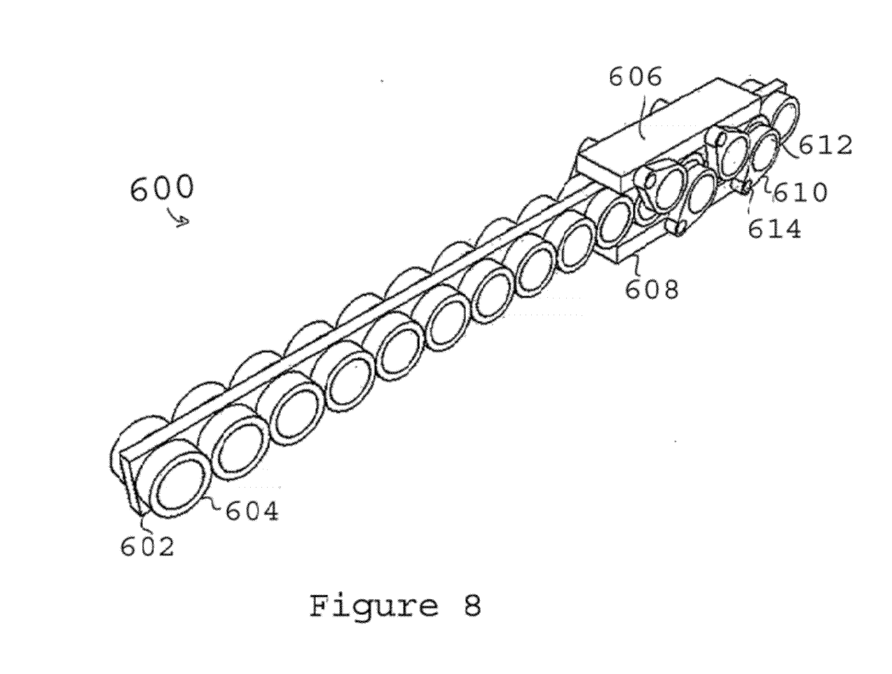

FIG. 8 shows the linear skate/rail embodiment 600 according to the present invention with the skate at a second intermediate position.

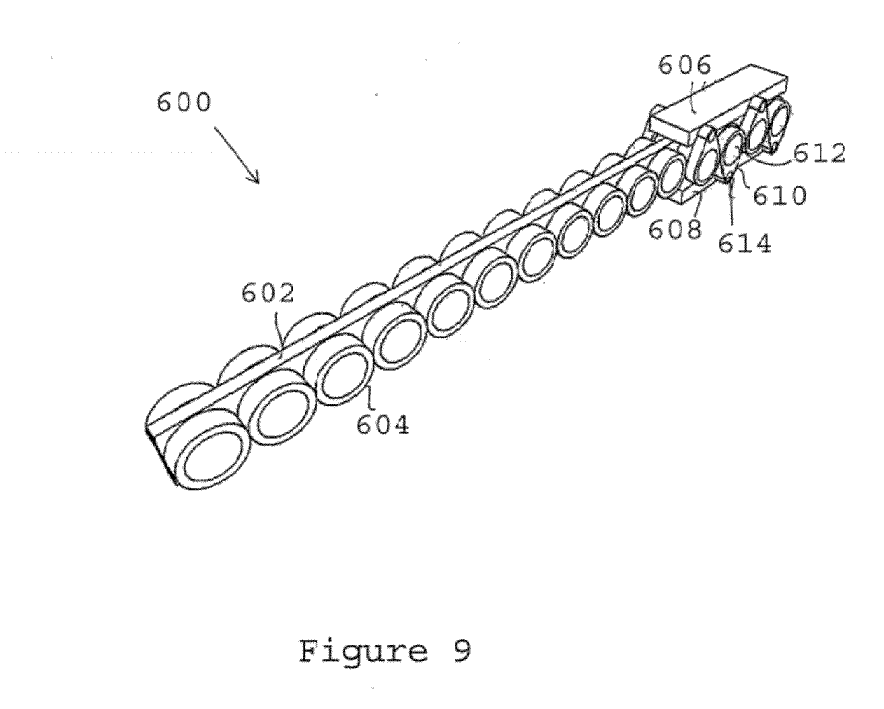

FIG. 9 shows the linear skate/rail embodiment 600 according to the present invention with the skate at a final position.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A rotor for use in a generator or motor comprising:
a hub having a central hole for receiving a rotation shaft;
a plurality of frames attached to the hub in a manner that allows the frame to flex or pivot with respect to the hub; and
a plurality of magnets, wherein at least one magnet is attached to each frame.

2. The rotor of claim 1 wherein the hub further comprises a plurality of first pivot holes, the plurality of frames each contain a corresponding second pivot hole, and each frame is attached to the hub with a pin.

3. The rotor of claim 1 wherein each frame comprises a trapezoidal-shaped frame.

4. The rotor of claim 1 wherein each magnet comprises a trapezoidal-shaped magnet.

5. The rotor of claim 1 wherein each frame is coupled to and separated from an adjacent frame with a spring.

6. The rotor of claim 1 wherein each frame is coupled to and separated from a chassis with a spring.

7. The rotor of claim 1 wherein two magnets are attached to each frame.

8. A generator or motor comprising:
a first stator;
a second stator; and
a rotor that rotates between the first and second stators, wherein the rotor comprises a hub having a central hole for receiving a rotation shaft, a plurality of frames attached to the hub in a manner that allows the frame to flex or pivot with respect to the hub, and a plurality of magnets, wherein at least one magnet is attached to each frame.

9. The generator or motor of claim 8 wherein the hub further comprises a plurality of first pivot holes, the plurality of frames each contain a corresponding second pivot hole, and each frame is attached to the hub with a pin.

10. The rotor of claim 8 wherein each frame comprises a trapezoidal-shaped frame.

11. The rotor of claim 8 wherein each magnet comprises a trapezoidal-shaped magnet.

12. The rotor of claim 8 wherein each frame is coupled to and separated from an adjacent frame with a spring.

13. The rotor of claim 8 wherein each frame is coupled to and separated from a chassis with a spring.

14. The rotor of claim 8 wherein two magnets are attached to each frame.

15. A generator or motor comprising:
a first plurality of stators; and
a second plurality of rotors,
wherein the second plurality is one less than the first plurality, each rotor rotates between adjacent stators, and each rotor comprises a hub having a central hole for receiving a rotation shaft, a plurality of frames attached to the hub in a manner that allows the frame to flex or pivot with respect to the hub, and a plurality of magnets, wherein at least one magnet is attached to each frame.

16. The generator or motor of claim 15 wherein the hub further comprises a plurality of first pivot holes, the plurality of frames each contain a corresponding second pivot hole, and each frame is attached to the hub with a pin.

17. The rotor of claim 15 wherein each frame comprises a trapezoidal-shaped frame.

18. The rotor of claim 15 wherein each magnet comprises a trapezoidal-shaped magnet.

19. The rotor of claim 15 wherein each frame is coupled to and separated from an adjacent frame with a spring.

20. The rotor of claim 15 wherein each frame is coupled to and separated from a chassis with a spring.

21. The rotor of claim 15 wherein two magnets are attached to each frame.

22. A method of saving energy in a generator or motor comprising a stator and a rotor comprising:
providing a rotor having a plurality of frames, each frame having at least one magnet; and
attaching the frames to a hub of the rotor in a manner that allows each frame to having a flexing or oscillating movement with respect to the hub, such that the flexing or oscillating movement reduces the resistance to movement by easing breaking of the magnetic force between the magnets of the rotor and a coil of the stator.

23. A generator or motor comprising:
a rail; and
a skate that slides across the rail, wherein the skate comprises:
an upper portion having a plurality of frames attached to the upper portion in a manner that allows the frame to flex or pivot with respect to the upper portion, and a plurality of magnets, wherein at least one magnet is attached to each frame; and
a lower portion having a plurality of frames attached to the lower portion in a manner that allows the frame to flex or pivot with respect to the upper portion, and a plurality of magnets, wherein at least one magnet is attached to each frame.

24. The generator or motor of claim 23 wherein the upper portion further comprises a plurality of first pivot holes, the plurality of frames each contain a corresponding second pivot hole, and each frame is attached to the upper portion with a pin.

25. The generator or motor of claim 23 wherein the lower portion further comprises a plurality of first pivot holes, the plurality of frames each contain a corresponding second pivot hole, and each frame is attached to the lower portion with a pin.

26. The generator or motor of claim 23 wherein each magnet comprises a circular-shaped magnet.

27. The generator or motor of claim 23 wherein successive magnets have opposite polarities.

28. The generator or motor of claim 23 wherein frames associated with the upper portion are interleaved with respect to frames from the lower portion.

29. The generator or motor of claim 23 further comprising a spring for returning the magnets to a perpendicular position.

30. A method of saving energy in a generator or motor comprising a fixed portion and a movable portion comprising:
providing the movable portion with a plurality of frames, each frame having at least one magnet; and
attaching the frames to the movable portion in a manner that allows each frame to having a flexing or oscillating movement with respect to the hub, such that the flexing or oscillating movement reduces the resistance to movement by easing breaking of the magnetic force between the magnets of the movable portion and a coil of the fixed portion.
